(19) United States
(12) Patent Application Publication
(10) Pub. No.: US 2026/0318181 A1
(43) Pub. Date: Oct. 15, 2026

(54) HYBRID MODELS FOR TARGET SELECTION IN AUTONOMOUS GEOSTEERING

(71) Applicant: Schlumberger Technology Corporation, Sugar Land, TX (US)

(72) Inventors: Bingqi Liu, Beijing (CN); Zhen Hua Li, Beijing (CN); Wanning Liu, Beijing (CN); Lu Jiang, Beijing (CN); Tao Yu, Beijing (CN); Pierre Bonningue, Beijing (CN); Zhi Yi Zhang, Beijing (CN); Yan Song Huang, Beijing (CN); Jing Wang, Beijing (CN); Joseph Gremillion, Sugar Land, TX (US); Michael Bower, Sugar Land, TX (US); Fei Wang, Tianjin (CN); Zining Liu, Beijing (CN); Qianyue Hao, Beijing (CN)

(21) Appl. No.: 19/178,885

(22) Filed: Apr. 15, 2025

(51) Int. Cl. E21B 44/00; G06F 17/17; G06N 3/092

(52) U.S. Cl. CPC E21B 44/00; G06F 17/17; G06N 3/092; E21B 2200/22

(57) ABSTRACT

Techniques for autonomously geosteering a drill bit to produce a borehole are presented. The techniques can include: obtaining real-time drill data during a drilling operation; passing the real-time drill data to a reinforcement learning system, from which an identification of a next drill action is obtained; determining a validated reinforcement learning next drill target from the next drill action, where the determining includes simulating the next drill action; extrapolating a statistical next upper boundary and a statistical next lower boundary from a previous upper boundary and a previous lower boundary, respectively; determining a validated statistical next drill target from the statistical next upper boundary and the statistical next lower boundary; and determining a next drilling target by combining the validated reinforcement learning next drill target and the at least one validated statistical next drill target.

### BACKGROUND

Conventional geosteering includes a geologist obtaining and interpreting data to identify a drilling target, updating a well plan and trajectory, and communicating this information to a directional driller. Existing autonomous geosteering attempts have not been capable identifying, in real-time, a drilling target based on various types of data, while ensuring safety and adherence to physical constraints in complex geologic environments. Therefore, what is needed is an improved system and method for autonomous geosteering.

### SUMMARY

According to various embodiments, systems, methods, and computer readable media for autonomously geosteering a drill bit to produce a borehole are presented. The techniques can include: during a drilling operation, obtaining real-time drill data, where the real-time drill data includes: geological interface data derived from inversion, a distance of the drill bit from an upper boundary, a distance of the drill bit to a lower boundary, an azimuth of the drill bit, drill pipe tool parameters, seismic data, geological data, and reservoir data; passing the real-time drill data to a reinforcement learning system, from which an identification of a next drill action is obtained, where the reinforcement learning system includes a neural network, where the neural network includes an input layer that receives the real-time drill data, a serial modeling layer, a low-level features layer, and a high-level features layer, where the neural network is trained with training data by an interactive agent process to output respective evaluations of a plurality of possible actions in response to an input of drill data, where the training data includes drill state data, drill action data, next drill state data, and reward data; simulating the next drill action, from which a reinforcement learning next drill target is obtained; validating the reinforcement learning next drill target using a first rules-based filtering, from which a validated reinforcement learning next drill target is obtained; extrapolating a weighted average next upper boundary and a weighted average next lower boundary from a previous upper boundary and a previous lower boundary, respectively, where the previous upper boundary and the previous lower boundary correspond to an already-drilled portion of the borehole during the drilling operation, where the extrapolating the weighted average next upper boundary and the weighted average next lower boundary includes obtaining a weighted average of dip angles based on the previous upper boundary and obtaining a weighted average of dip angles based on the previous lower boundary; determining a weighted average next drill target from the weighted average next upper boundary and the weighted average next lower boundary; validating the weighted average next drill target using a second rules-based filtering, from which a validated weighted average next drill target is obtained; extrapolating a reference surface next upper boundary and a reference surface next lower boundary from the previous upper boundary and the previous lower boundary, respectively, where the extrapolating the reference surface next upper boundary and the reference surface next lower boundary includes aligning a upper reference surface to the previous upper boundary and aligning a lower reference surface to the previous lower boundary; determining a reference surface next drill target from the reference surface next upper boundary and the reference surface next lower boundary; validating the reference surface next drill target using a third rules-based filtering, from which a validated reference surface next drill target is obtained; extrapolating an autoregression next upper boundary and an autoregression next lower boundary from the previous upper boundary and the previous lower boundary, respectively, where the extrapolating the autoregression next upper boundary and the autoregression next lower boundary includes training a lower autoregression process with the previous lower boundary and training an upper autoregression process with the previous upper boundary; determining an autoregression next drill target from the autoregression next upper boundary and the autoregression next lower boundary; validating the autoregression next drill target using a fourth rules-based filtering, from which a validated autoregression next drill target is obtained; combining the validated reinforcement learning next drill target, the validated weighted average next drill target, the validated reference surface next drill target, and the validated autoregression next drill target using ensemble learning, from which a next drill target is obtained; and geosteering the drill bit in the borehole to the next drill target, where the drill bit extends the borehole to the next drill target.

Various optional features include the following. Respective reward data may quantify whether respective next drill state data corresponds to a location within a reservoir, and respective reward data may further quantify whether respective next drill state data corresponds to a location between a respective upper boundary and a respective lower boundary. The identification of the next drill action may include respective values for rate of penetration, toolface, steering ratio, weight on bit, and torque. The ensemble learning may assign respective weights to the validated reinforcement learning next drill target, the validated weighted average next drill target, the validated reference surface next drill target, and the validated autoregression next drill target based on past performance and reliability. The reinforcement learning system may include a deep Q-network, where the deep Q-network includes the neural network.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates an example of training data portions, where the training data portions include synthetic observation data to simulate various drilling scenarios, according to an embodiment.

FIG. 3 is a schematic diagram of a neural network, according to an embodiment.

FIG. 4 depicts an example of statistical extrapolation of boundaries according to an embodiment.

FIG. 5 depicts a system for autonomously geosteering a drill bit to produce a borehole according to an embodiment.

FIG. 6 illustrates a flowchart of a method for autonomously geosteering a drill bit to produce a borehole, according to an embodiment.

FIG. 7 illustrates a schematic view of a computing system for performing at least a portion of the method of autonomously geosteering a drill bit to produce a borehole, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

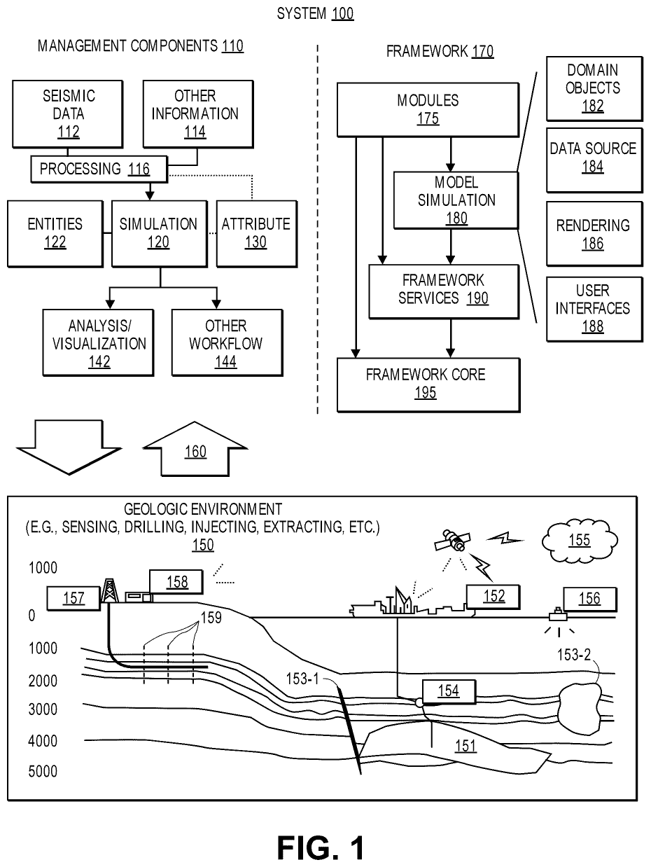

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### Hybrid Models for Target Selection in Autonomous Geosteering

The present disclosure describes techniques for target selection in autonomous geosteering that employ hybrid models, including both machine learning and one or more statistical models. Some embodiments solve the problem of making real-time decisions for a next drilling target point based on various types of data, while ensuring safety and adherence to physical constraints. Some embodiments solve the problem of existing statistical techniques, which lack the adaptability and performance potential of newer techniques. Some embodiments solve the problem of existing machine learning techniques, which, though powerful, can sometimes produce unreliable or unrealistic outcomes. Some embodiments solve the aforementioned problems through the use of a hybrid model that combines both reinforcement learning, a type of machine learning, with statistical techniques that consider physical constraints, thereby leveraging the strengths of both approaches to improve decision-making in autonomous geosteering.

Some embodiments include a hybrid model that combines reinforcement learning with statistical methods to guide the drill bit in autonomous geosteering. According to some embodiments, reinforcement learning is employed for its ability to make real-time decisions based on a wide array of data sources, such as geological interface data, drilling parameters, and seismic interpretations. According to some embodiments, to mitigate the issue of reinforcement learning's occasional unreliability and “black box” nature, a hybrid model integrates these real-time decisions with statistical automation system that enforces physical constraints. This ensures that the drilling process according to some embodiments remains safe and realistic, preventing dangerous or impractical outcomes while optimizing well placement.

The hybrid model according to some integrates reinforcement learning with statistical physics-based methods to ensure decisions are both optimal and realistic. Some embodiments thus leverage reinforcement learning's strength in processing and analyzing diverse, real-time data sources (e.g., geological, drilling parameters, seismic interpretations, and more) to make immediate decisions, which many traditional methods may struggle with. Some embodiments also incorporate physical constraints into the decision-making process through the use of statistical methods, ensuring that actions are safe and feasible, and preventing dangerous or unrealistic outcomes that could result from a purely data-driven model. Overall, the hybrid approach according to some embodiments offers a balanced solution that maximizes the strengths of both reinforcement learning and statistical physics-based methods, providing a more robust, reliable, and safe method for autonomous geosteering. Some embodiments not only optimize well placement, but also reduce operational risks, thus improving drilling efficiency.

Some embodiments use a comprehensive set of both real-time and historical data to identify a next drill target, including any, or a combination, of: real-time geological interface data derived from inversion (an “inversion” reconstructs a geology from sensed data; for example, surface seismic data, vertical seismic profiles and well log data can be used to perform inversion, the result of which is a model of Earth layers and their thickness, density and P-and S-wave velocities), the drill bit's distance from upper and lower boundaries, the drill bit's azimuth and real-time drilling parameters, drill pipe tool parameters (e.g., rate of penetration, toolface, steering ratio, weight on bit, and/or torque), seismic interpretations, geological, and/or reservoir characteristics.

These and other features and advantages are shown and described presently in reference to the figures.

This disclosure proceeds to show and describe a hybrid model according to some embodiments, first by presenting a machine learning reinforcement learning system, then by presenting various statistical models, and then by presenting a hybrid model that includes features from both model types.

The reinforcement learning system according to some embodiments processes real-time drill data to make real-time decisions about the next optimal target for the drill bit. For example, the reinforcement learning system may accept real-time drill state data and process it in real time to produce an identification of a next drill action. The output may include a specified rate of penetration (e.g., drill speed) and/or a specified toolface (e.g., a specified angle measured in a plane perpendicular to the drillstring axis that is between a reference direction on the drillstring and a fixed reference).

Prior to deployment, the reinforcement learning system is trained with training data to output evaluations of each of a plurality of possible actions in response to an input of drill data. According to some embodiments, the training data includes a large number of training data, where each training datum specifies: drill state data, drill action data, next drill state data, and reward data. The reward data in a training datum may quantify the acceptability of the next drill state. For example, if the next drill state produced by the drill action specified in the training datum is outside the reservoir, then the reward may be negative and in proportion to the distance outside of the reservoir. If the next drill state is within the reservoir, the reward may be positive. Likewise, if the next drill state is outside of a specified boundary, the reward may be negative; otherwise, the reward may be positive. In general, the reward may include multiple components, such as any of the aforementioned and/or other components.

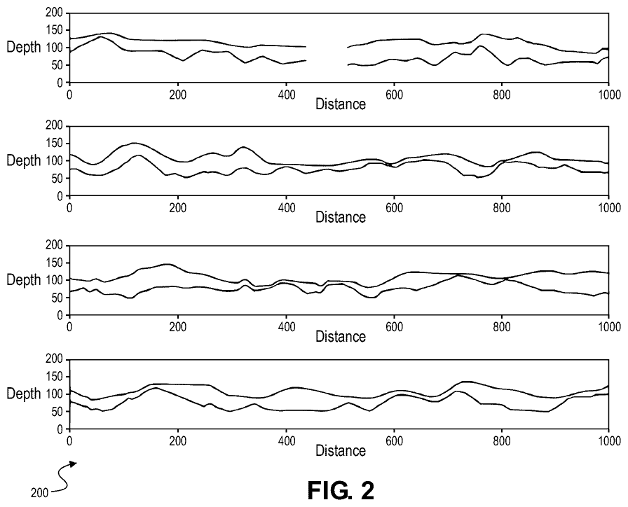

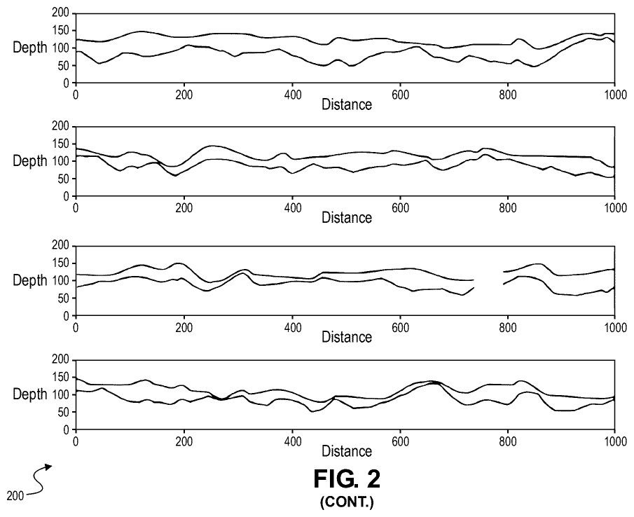

FIG. 2 illustrates an example of training data portions 200, where the training data portions include synthetic observation data to simulate various drilling scenarios, according to an embodiment. Each graph in FIG. 2 represents distance from the wellhead on the x-axis and depth on the y-axis. Embodiments may use synthetic dataset for model training and validate it with some real data. In an example implementation, the inventors found that both datasets exhibited similar performance level, indicating that synthetic data may effectively reflect real-world scenarios.

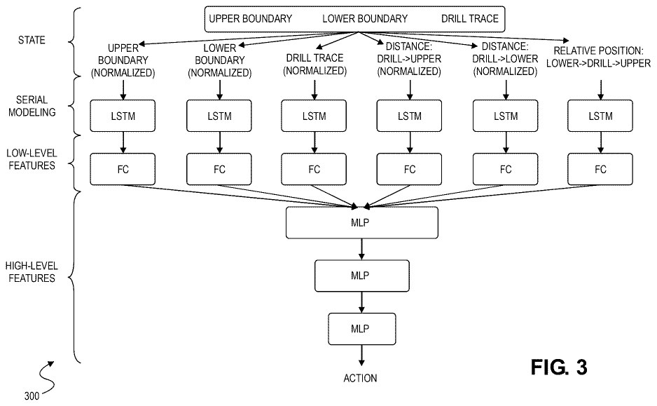

FIG. 3 is a schematic diagram of a neural network 300 of a reinforcement learning system, according to an embodiment. According to some embodiments, the reinforcement learning system includes a deep Q-network. The reinforcement learning system may include an agent and a neural network 300, as shown in FIG. 3. The neural network 300 may be trained with training data by an interactive agent process. The neural network 300 may include a plurality of layers, including an input layer that receives drill state data. The drill state data may include real-time drill data when the embodiment is deployed. The drill state data may include upper boundary data, lower boundary data, and/or trajectory (e.g., drill trace) data. For example, the drill state data may include any, or a combination, of: normalized upper boundary data, normalized lower boundary data, normalized drill trace data, a normalized distance between the drill and the upper boundary, a normalized distance between the drill and the lower boundary, and/or data indicative of a relative position of the drill between the upper boundary and the lower boundary. The input layer may be coupled to a serial modeling layer, which receives an indication of a prior path and produces an indication of a next path. According to some embodiments, the serial modeling layer may include one or more long short-term memory layers. The serial modeling layer may be coupled to a low-level feature layer, which receives indications of next paths and produces low-level features. According to some embodiments, the low-level features layer may include one or more fully convolutional layers, e.g., arranged in parallel. The low-level features layer may be coupled to a high-level features layer, which receives low-level features and produces high-level features. According to some embodiments, the high-level features layer may include one or more multi-layer perceptron layers, e.g., arranged in series. The high-level features layer may produce drill action data, e.g., a rate of penetration value and/or a toolface value.

Some embodiments include a simulator that accepts drill action data from the reinforcement learning system and simulates a drill action to obtain a next drill target. The drill action and simulation may be for a specified distance, e.g., 20 meters. For example, an embodiment may set a simulated drilling distance of 20 meters, and the next drill target from the reinforcement learning system can be obtained through the drilling simulator. In general, the reinforcement learning system according to some embodiments is able to learn from a wide range of simulated experiences, refining its policy to make more informed decisions during actual drilling operations.

In addition to the reinforcement learning system, some embodiments include one or more statistical extrapolation techniques. The statistical extrapolation techniques may be employed to enforce physical constraints on the drilling process. The constraints produced by the statistical extrapolation technique(s) ensure that the decisions made by the reinforcement learning system are realistic, feasible, and safe. Some embodiments use the statistical extrapolation techniques to extrapolate upper and lower boundaries in order to predict the layer tendency, and these extrapolated boundaries may be used as physical constraints during the drilling target selection process.

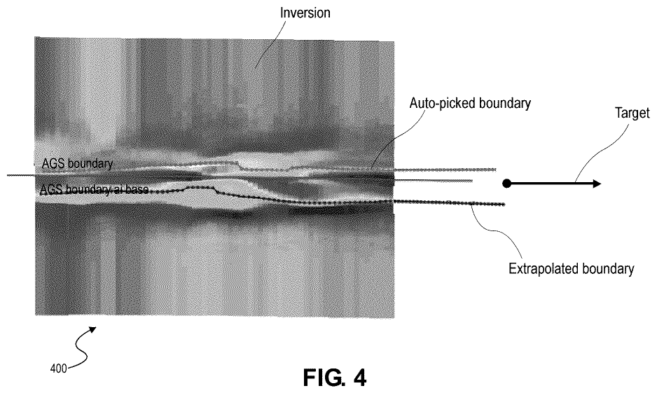

FIG. 4 depicts an example of statistical extrapolation 400 of boundaries according to an embodiment. In particular, FIG. 4 shows a cross section of geological strata generated by an inversion. Previous upper and lower boundaries are shown, as well as extrapolated upper and lower boundaries. Various embodiments may use the boundaries to constrain a drill path and obtain a drill target that is realistic, feasible, and safe.

By way of non-limiting example, this disclosure proceeds to describe three statistical extrapolation techniques: weighted average, reference surface, and autoregression.

The weighted average statistical extrapolation technique utilizes the upper and lower boundary data from the last 200 meters, by way of non-limiting example, for extrapolation purposes. The technique computes the average dip angles of the strata over the final 50 meters, 100 meters, and 200 meters. These three average values are then used to calculate a weighted average dip angle, which serves as the basis for linear extrapolation. To determine the weighted average dip angle, the standard deviations of the dip angles over 50 meters and 200 meters are compared to assess the degree of dip angle variation both in the regionally and locally. If the variation in the region is found to be greater, a higher weight is assigned to the dip angle values from this region. Conversely, if the local variation is more significant, a higher weight is assigned to the local dip angle values.

The reference surface statistical extrapolation technique selects the boundary of the final segment and compares it with the reference surface to identify the most similar region. Using the boundary as a reference, rotation and translation of the selected portion of the surface is performed to ensure alignment with the boundary. The adjusted surface is subsequently employed as the extrapolated boundary.

The autoregression statistical extrapolation technique generates predicted boundary points by expressing the last picked boundary point as a linear combination of the previous values. The autoregression model may be trained using boundary points to obtain the model parameters. A single-step prediction may be made using the model, yielding the first predicted boundary point. This first predicted value may then be used as new input data, and the previous step may be repeated until the desired number of prediction steps is achieved.

The non-limiting example three statistical extrapolation techniques expressly disclosed herein are aimed at extrapolating the upper and lower boundaries. Once the boundary extrapolation is determined, the next drill target may be set within upper and lower boundaries. By way of non-limiting examples, the next drill target may be set as being in the middle of the boundaries, or a fixed distance from either boundary.

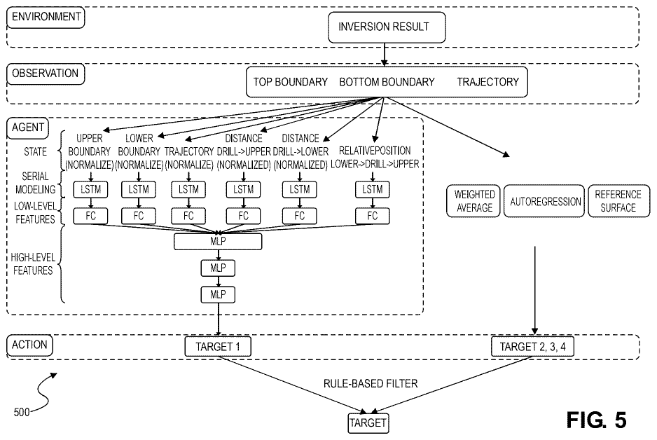

FIG. 5 depicts a system 500 for autonomously geosteering a drill bit to produce a borehole according to an embodiment. The system 500 incorporates a reinforcement learning system, as shown and described herein in reference to FIG. 2 and FIG. 3, as well as one or more statistical extrapolation techniques, as shown and described herein in reference to FIG. 4. The system 500 operates in the context of a simulation environment, which may include the results of an inversion. The system 500 accepts observations, such as real-time drill state data, which may include one or more of: upper boundary data, lower boundary data, and/or trajectory data. The system 500 passes the drill state data to both the reinforcement learning system and the statistical extrapolation techniques, which produce respective next drill targets. The next drill targets may be for a predetermined distance, such as, by way of non-limiting example, 20 meters. The system 500 validates (as described in detail below) and then combines the respective next drill targets, e.g., using an ensemble learning technique, to generate a next drill target. The next drill target may be passed to drill equipment to automatically geosteer the drill bit in the borehole to the next drill target, such that the drill bit extends the borehole to the next drill target

Further details of the system 500 follow. In general, the reinforcement learning system's decisions may be cross-validated with the statistical extrapolation techniques. Some embodiments include one or more rule-based filtering systems to validate the outputs from both the reinforcement learning system and the statistical extrapolation techniques before making a final decision. A non-limiting example of such a rule-based filtering system may implement safety rules that check for unrealistic outputs, such as the upper boundary intersecting with the lower boundary, the next drill target being lower than the lower boundary, etc. If such conditions are detected, the decision from any of the reinforcement learning system or the statistical extrapolation techniques can be overridden or adjusted. As another example, some embodiments may implement consistency checks to ensure that the extrapolation trends align with historical data and observed geological formations.

After applying the rule-based filtering, if there are still two possible targets, the system 500 may combine the outputs of the reinforcement learning system and the statistical extrapolation techniques using an ensemble learning approach, which can help in making more robust decisions. Weights may be assigned to the next drill target outputs of the reinforcement learning system and the statistical extrapolation techniques based on their past performance and reliability. The final next drill target may be a weighted average of both outputs. The hybrid approach according to some embodiments ensures that the final next drill target decisions are both optimal and safe, mitigating the risks associated with purely data-driven models.

In general, a method implemented by the system 500 may proceed as follows. First, as an initial setup, the drilling operation may begin with initial geological data and drilling parameters. Second, the system 500 may perform real-time data processing. As drilling progresses, real-time data from various sources may be continuously fed into the system 500. Third, the reinforcement learning system analyzes the data and suggests an optimal path for the drill bit. Fourth, the system 500 enforces constraints, e.g., as set according to the statistical extrapolation techniques. The next drill target from the reinforcement learning system may be validated against physical constraints to ensure safety and feasibility. Fifth, the system 500 provides a final next drill target decision. A balanced, optimal, and safe decision may be provided, guiding the drill bit's movement in real time and in response to real-time drill state data.

### Exemplary Method

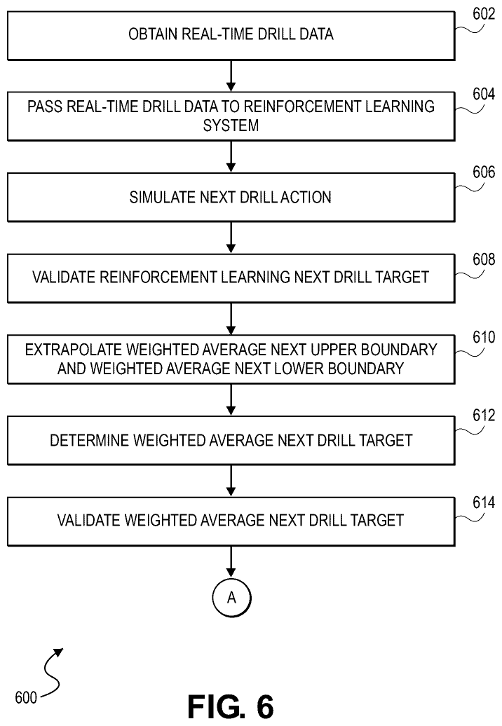

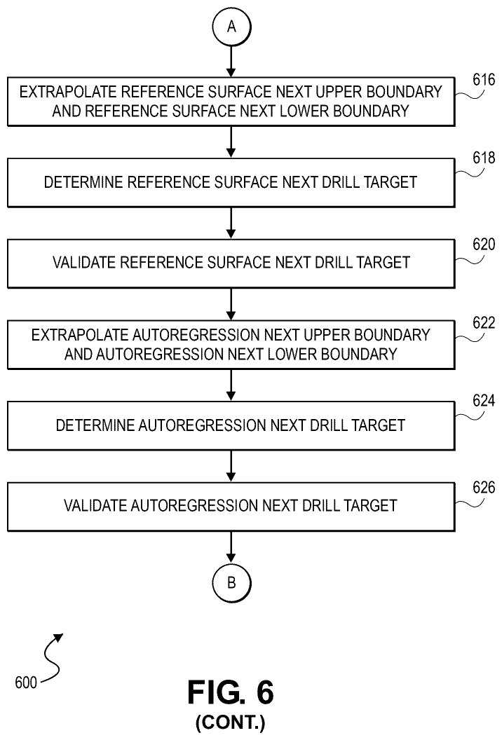

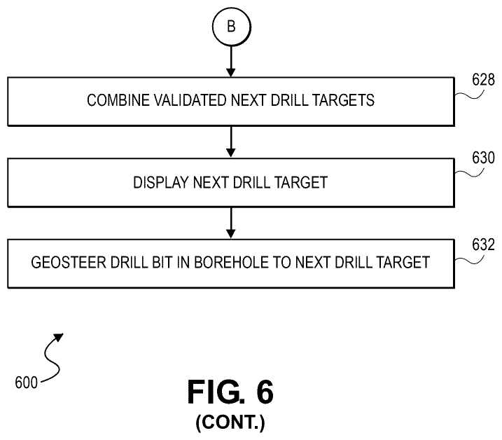

FIG. 6 illustrates a flowchart of a method for autonomously geosteering a drill bit to produce a borehole, according to an embodiment. An illustrative order of the method 600 is provided below; however, one or more portions of the method 600 may be performed in a different order, simultaneously, repeated, or omitted. At least a portion of the method 600 may be performed by a computing system (described below).

The method 600 may include, during a drilling operation, obtaining real-time drill data, as at 602. The real-time drill data may include any, or a combination, of: geological interface data derived from inversion, a distance of the drill bit from an upper boundary, a distance of the drill bit to a lower boundary, an azimuth of the drill bit, drill pipe tool parameters, seismic data, geological data, and/or reservoir data.

The method 600 may include passing the real-time drill data to a reinforcement learning system, from which an identification of a next drill action is obtained, as at 604. The reinforcement learning system may include a neural network, and the neural network may include an input layer that receives the real-time drill data, a serial modeling layer, a low-level features layer, and a high-level features layer. The neural network may be trained with training data by an interactive agent process to output respective evaluations of a plurality of possible actions in response to an input of drill data. The training data may include drill state data, drill action data, next drill state data, and reward data.

The method 600 may include simulating the next drill action, from which a reinforcement learning next drill target is obtained, as at 606.

The method 600 may include validating the reinforcement learning next drill target using a first rules-based filtering, from which a validated reinforcement learning next drill target is obtained, as at 608.

The method 600 may include extrapolating a weighted average next upper boundary and a weighted average next lower boundary from a previous upper boundary and a previous lower boundary, respectively, as at 601. The previous upper boundary and the previous lower boundary may correspond to an already-drilled portion of the borehole during the drilling operation. The extrapolating the weighted average next upper boundary and the weighted average next lower boundary may include obtaining a weighted average of dip angles based on the previous upper boundary and obtaining a weighted average of dip angles based on the previous lower boundary.

The method 600 may include determining a weighted average next drill target from the weighted average next upper boundary and the weighted average next lower boundary, as at 612.

The method 600 may include validating the weighted average next drill target using a second rules-based filtering, from which a validated weighted average next drill target is obtained, as at 614.

The method 600 may include extrapolating a reference surface next upper boundary and a reference surface next lower boundary from the previous upper boundary and the previous lower boundary, respectively, as at 616. The extrapolating the reference surface next upper boundary and the reference surface next lower boundary may include aligning an upper reference surface to the previous upper boundary and aligning a lower reference surface to the previous lower boundary.

The method 600 may include determining a reference surface next drill target from the reference surface next upper boundary and the reference surface next lower boundary, as at 618.

The method 600 may include validating the reference surface next drill target using a third rules-based filtering, from which a validated reference surface next drill target is obtained, as at 620.

The method 600 may include extrapolating an autoregression next upper boundary and an autoregression next lower boundary from the previous upper boundary and the previous lower boundary, respectively, as at 622. The extrapolating the autoregression next upper boundary and the autoregression next lower boundary may include training a lower autoregression process with the previous lower boundary and training an upper autoregression process with the previous upper boundary.

The method 600 may include determining an autoregression next drill target from the autoregression next upper boundary and the autoregression next lower boundary, as at 624.

The method 600 may include validating the autoregression next drill target using a fourth rules-based filtering, from which a validated autoregression next drill target is obtained, as at 626.

The method 600 may include combining the validated reinforcement learning next drill target, the validated weighted average next drill target, the validated reference surface next drill target, and the validated autoregression next drill target using ensemble learning, from which a next drill target is obtained, as at 628.

The method 600 may also include displaying the next drill target, as at 630.

The method 600 may include geosteering the drill bit in the borehole to the next drill target, where the drill bit extends the borehole to the next drill target, as at 630. This action may be or include generating and/or transmitting a signal that recommends, instructs, or causes a physical action to occur at a wellsite that is proximate to the reservoir. The physical action may be or include selecting where to drill a wellbore, drilling the wellbore, varying a weight and/or torque on a drill bit that is drilling the wellbore, varying a drilling trajectory of the wellbore, or varying a concentration and/or flow rate of a fluid pumped into the wellbore.

### Exemplary Computing System

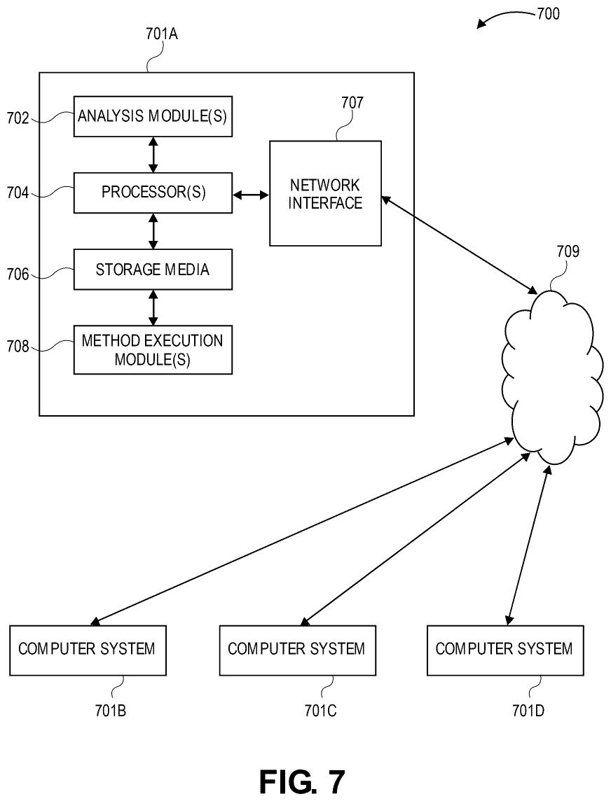

In various embodiments, the methods of the present disclosure may be executed by one or more computing systems. FIG. 7 illustrates an example of such a computing system 700, in accordance with some embodiments. The computing system 700 may include a computer or computer system 701A, which may be an individual computer system 701A or an arrangement of distributed computer systems. The computer system 701A includes one or more analysis modules 402 that are configured to perform various tasks according to some embodiments, such as one or more methods disclosed herein. To perform these various tasks, the analysis module 702 executes independently, or in coordination with, one or more processors 704, which is (or are) connected to one or more storage media 706. The processor(s) 704 is (or are) also connected to a network interface 707 to allow the computer system 701A to communicate over a data network 709 with one or more additional computer systems and/or computing systems, such as 701B, 701C, and/or 701D (note that computer systems 701B, 701C and/or 701D may or may not share the same architecture as computer system 701A, and may be located in different physical locations, e.g., computer systems 701A and 701B may be located in a processing facility, while in communication with one or more computer systems such as 701C and/or 701D that are located in one or more data centers, and/or located in varying countries on different continents).

A processor may include a microprocessor, microcontroller, processor module or subsystem, programmable integrated circuit, programmable gate array, or another control or computing device.

The storage media 706 may be implemented as one or more computer-readable or machine-readable storage media. Note that while in the example embodiment of FIG. 7 storage media 706 is depicted as within computer system 701A, in some embodiments, storage media 706 may be distributed within and/or across multiple internal and/or external enclosures of computing system 701A and/or additional computing systems. Storage media 706 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 700 contains one or more method execution module(s) 708. In the example of computing system 700, computer system 701A includes the method execution module 708. In some embodiments, a single method execution module may be used to perform some aspects of one or more embodiments of the methods disclosed herein. In other embodiments, a plurality of method execution modules may be used to perform some aspects of methods herein.

It should be appreciated that computing system 700 is merely one example of a computing system, and that computing system 700 may have more or fewer components than shown, may combine additional components not depicted in the example embodiment of FIG. 7, and/or computing system 700 may have a different configuration or arrangement of the components depicted in FIG. 7. The various components shown in FIG. 7 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 700, FIG. 7), and/or through manual control by a user who may make determinations regarding whether a given step, action, template, model, or set of curves has become sufficiently accurate for the evaluation of the subsurface three-dimensional geologic formation under consideration.

The foregoing description, for purposes of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method of autonomously geosteering a drill bit to produce a borehole, the method comprising:
obtaining real-time drill data during a drilling operation;
passing the real-time drill data to a reinforcement learning system, from which an identification of a next drill action is obtained;
determining a validated reinforcement learning next drill target from the next drill action, wherein the determining comprises simulating the next drill action;
extrapolating at least one statistical next upper boundary and at least one statistical next lower boundary from a previous upper boundary and a previous lower boundary, respectively;
determining at least one validated statistical next drill target from the at least one statistical next upper boundary and the at least one statistical next lower boundary; and
determining a next drilling target by combining the validated reinforcement learning next drill target and the at least one validated statistical next drill target.

2. The method of claim 1, wherein the real-time drill data comprises: geological interface data derived from inversion, a distance of the drill bit from an upper boundary, a distance of the drill bit to a lower boundary, an azimuth of the drill bit, drill pipe tool parameters, seismic data, geological data, and reservoir data.

3. The method of claim 1, wherein the extrapolating at least one statistical next upper boundary and at least one statistical next lower boundary comprises:
extrapolating a weighted average next upper boundary and a weighted average next lower boundary from the previous upper boundary and the previous lower boundary, respectively, wherein the extrapolating the weighted average next upper boundary and the weighted average next lower boundary comprises obtaining a weighted average of dip angles based on the previous upper boundary and obtaining a weighted average of dip angles based on the previous lower boundary.

4. The method of claim 1, wherein the extrapolating at least one statistical next upper boundary and at least one statistical next lower boundary comprises:
extrapolating a reference surface next upper boundary and a reference surface next lower boundary from the previous upper boundary and the previous lower boundary, respectively, wherein the extrapolating the reference surface next upper boundary and the reference surface next lower boundary comprises aligning an upper reference surface to the previous upper boundary and aligning a lower reference surface to the previous lower boundary.

5. The method of claim 1, wherein the extrapolating at least one statistical next upper boundary and at least one statistical next lower boundary comprises:
extrapolating an autoregression next upper boundary and an autoregression next lower boundary from the previous upper boundary and the previous lower boundary, respectively, wherein the extrapolating the autoregression next upper boundary and the autoregression next lower boundary comprises training a lower autoregression process with the previous lower boundary and training an upper autoregression process with the previous upper boundary.

6. The method of claim 1, wherein the reinforcement learning system is trained using training data by an interactive agent process to output respective evaluations of a plurality of possible actions in response to an input of drill data.

7. The method of claim 6, wherein the reinforcement learning system comprises a neural network, wherein the neural network comprises an input layer that receives the real-time drill data, a serial modeling layer, a low-level features layer, and a high-level features layer, and wherein the reinforcement learning system is trained by training the neural network.

8. The method of claim 6, wherein the training data comprises drill state data, drill action data, next drill state data, and reward data.

9. The method of claim 1, wherein the previous upper boundary and the previous lower boundary correspond to an already-drilled portion of the borehole during the drilling operation, and wherein the extrapolating the at least one statistical next upper boundary and the at least one statistical next lower boundary comprises applying statistical extrapolation techniques to the previous upper boundary and applying the statistical extrapolation techniques the previous lower boundary.

10. The method of claim 1,
wherein the extrapolating comprises extrapolating at least two statistical next upper boundaries and at least two statistical next lower boundaries,
wherein the determining the at least one validated statistical next drill target comprises determining at least two validated weighted average next drill targets from the at least two statistical next upper boundaries and the at least two statistical next lower boundaries, and
wherein the combining comprises combining the validated reinforcement learning next drill target and the at least two validated statistical next drill targets.

11. A computing system, comprising:
one or more processors; and
a memory system comprising one or more non-transitory computer-readable media storing instructions that, when executed by at least one of the one or more processors, cause the computing system to perform operations for autonomously geosteering a drill bit to produce a borehole, the operations comprising:
during a drilling operation, obtaining real-time drill data;
passing the real-time drill data to a reinforcement learning system, from which an identification of a next drill action is obtained;
determining a validated reinforcement learning next drill target from the next drill action, wherein the determining comprises simulating the next drill action;
extrapolating a plurality of statistical next upper boundaries and a plurality of statistical next lower boundaries from a previous upper boundary and a previous lower boundary, respectively, wherein the previous upper boundary and the previous lower boundary correspond to an already-drilled portion of the borehole during the drilling operation, wherein the extrapolating the plurality of statistical next upper boundaries and the plurality of statistical next lower boundaries comprises applying a plurality of statistical extrapolation techniques to the previous upper boundary and applying the plurality of statistical extrapolation techniques the previous lower boundary, wherein the statistical extrapolation techniques comprise: extrapolating weighted average boundaries, extrapolating reference surface boundaries, and extrapolating autoregression boundaries;
determining at least one validated statistical next drill target from the at least one statistical next upper boundary and the at least one statistical next lower boundary;
combining the validated reinforcement learning next drill target and the at least one validated statistical next drill target, from which a next drill target is obtained; and
geosteering the drill bit in the borehole to the next drill target, wherein the drill bit extends the borehole to the next drill target.

12. The computing system of claim 11, wherein the reinforcement learning system comprises a neural network, wherein the neural network is trained with training data by an interactive agent process to output respective evaluations of a plurality of possible actions in response to an input of drill data.

13. The computing system of claim 12, wherein the neural network comprises an input layer that receives the real-time drill data, a serial modeling layer, a low-level features layer, and a high-level features layer.

14. The computing system of claim 12, wherein the training data comprises drill state data, drill action data, next drill state data, and reward data.

15. The computing system of claim 11, wherein the reinforcement learning system comprises a deep Q-network.

16. A non-transitory computer-readable medium storing instructions that, when executed by one or more processors of a computing system, cause the computing system to perform operations for autonomously geosteering a drill bit to produce a borehole, the operations comprising:
during a drilling operation, obtaining real-time drill data, wherein the real-time drill data comprises: geological interface data derived from inversion, a distance of the drill bit from an upper boundary, a distance of the drill bit to a lower boundary, an azimuth of the drill bit, drill pipe tool parameters, seismic data, geological data, and reservoir data;
passing the real-time drill data to a reinforcement learning system, from which an identification of a next drill action is obtained, wherein the reinforcement learning system comprises a neural network, wherein the neural network comprises an input layer that receives the real-time drill data, a serial modeling layer, a low-level features layer, and a high-level features layer, wherein the neural network is trained with training data by an interactive agent process to output respective evaluations of a plurality of possible actions in response to an input of drill data, wherein the training data comprises drill state data, drill action data, next drill state data, and reward data;
simulating the next drill action, from which a reinforcement learning next drill target is obtained;
validating the reinforcement learning next drill target using a first rules-based filtering, from which a validated reinforcement learning next drill target is obtained;
extrapolating a weighted average next upper boundary and a weighted average next lower boundary from a previous upper boundary and a previous lower boundary, respectively, wherein the previous upper boundary and the previous lower boundary correspond to an already-drilled portion of the borehole during the drilling operation, wherein the extrapolating the weighted average next upper boundary and the weighted average next lower boundary comprises obtaining a weighted average of dip angles based on the previous upper boundary and obtaining a weighted average of dip angles based on the previous lower boundary;
determining a weighted average next drill target from the weighted average next upper boundary and the weighted average next lower boundary;
validating the weighted average next drill target using a second rules-based filtering, from which a validated weighted average next drill target is obtained;
extrapolating a reference surface next upper boundary and a reference surface next lower boundary from the previous upper boundary and the previous lower boundary, respectively, wherein the extrapolating the reference surface next upper boundary and the reference surface next lower boundary comprises aligning a upper reference surface to the previous upper boundary and aligning a lower reference surface to the previous lower boundary;
determining a reference surface next drill target from the reference surface next upper boundary and the reference surface next lower boundary;
validating the reference surface next drill target using a third rules-based filtering, from which a validated reference surface next drill target is obtained;
extrapolating an autoregression next upper boundary and an autoregression next lower boundary from the previous upper boundary and the previous lower boundary, respectively, wherein the extrapolating the autoregression next upper boundary and the autoregression next lower boundary comprises training a lower autoregression process with the previous lower boundary and training an upper autoregression process with the previous upper boundary;
determining an autoregression next drill target from the autoregression next upper boundary and the autoregression next lower boundary;
validating the autoregression next drill target using a fourth rules-based filtering, from which a validated autoregression next drill target is obtained;
combining the validated reinforcement learning next drill target, the validated weighted average next drill target, the validated reference surface next drill target, and the validated autoregression next drill target using ensemble learning, from which a next drill target is obtained; and
geosteering the drill bit in the borehole to the next drill target, wherein the drill bit extends the borehole to the next drill target.

17. The non-transitory computer-readable medium of claim 16, wherein respective reward data quantifies whether respective next drill state data corresponds to a location within a reservoir, and wherein respective reward data further quantifies whether respective next drill state data corresponds to a location between a respective upper boundary and a respective lower boundary.

18. The non-transitory computer-readable medium of claim 16, wherein the identification of the next drill action comprises respective values for rate of penetration, toolface, steering ratio, weight on bit, and torque.

19. The non-transitory computer-readable medium of claim 16, wherein the ensemble learning assigns respective weights to the validated reinforcement learning next drill target, the validated weighted average next drill target, the validated reference surface next drill target, and the validated autoregression next drill target based on past performance and reliability.

20. The non-transitory computer-readable medium of claim 16, wherein the reinforcement learning system comprises a deep Q-network, wherein the deep Q-network comprises the neural network.
